(19) United States
(12) Patent Application Publication
(10) Pub. No.: US 2007/0288662 A1
(43) Pub. Date: Dec. 13, 2007

(54) Distributed push-pull information service system

(75) Inventor: Chu Tsung Chen, Taipei (TW)

Correspondence Address: TROXELL LAW OFFICE PLLC;SUITE 1404, 5205 LEESBURG PIKE, FALLS CHURCH, VA, 22041, US

(73) Assignee: TelePaq Technology Inc.

(21) Appl. No.: 11/450,469

(22) Filed: Jun. 12, 2006

(51) Int. Cl. G06F 15/16

(52) U.S. Cl. 709/247

(57) ABSTRACT

A distributed push-pull information service system comprises an information service server and at least one client device. The server provides at least a first kind of information in a pushing basis by means of broadcasting and a second kind of information in a pulled basis by means of user demand. The client device can receive the broadcasted first kind of information and send a pulling request to the server for acquiring the second kind of information. The first and second kinds of information are transmitted by means of compressed and encrypted raw data. The client device further comprises a graphic user interface module for transforming at least part of the transmitted raw data into a graphic which is then displayed on the client device. The pulling request includes a search request which contains at least a specific term and a specific time period to be searched. Any information stored in the server meets that specific term during that specific period of time will be transmitted back to the client device as a result of search. The distributed information service system of the present invention also discloses the concept of “Intelligent Pull”, when the user makes a pull request, only the information which is absent in the memory of client device will be pulled, and thus the usage of bandwidth is highly efficient.

### BACKGROUND OF INVENTION

1. Field of the Invention

The present invention is related to a distributed push-pull information service system, and more particularly to an information service system which can broadcast realtime information to a plurality of client devices in a pushing basis, and can provide demanded information to a specific client device based on a pulling request made by that client device.

2. Description of the Prior Art

Along with the swift advance of information technology, the demands for instant and convenient access to information and communications undergo explosive growth. A wide varieties of portable wireless communication products that offer multiple functions, such as mobile phone, smart phone, and personal digital assistant (PDA) with wireless communication functions, have been developed to meet the needs and convenience of daily living.

New generations of mobile phone and PDA offer many extra functions in addition to making calls, for example, receiving and viewing stock information, placing orders to buy/sell stocks, directory, calendar, mobile secretary, webpage browsing, reading news, acquiring leisure information, and receiving and sending e-mails. Many of these functions involve in the needs to download vast amount of data from an information service system, such as a stock data provider, a news provider, or an internet search engine. Conventional information service systems tend to over-send data to their client devices (for example, mobile phone, smart phone, and PDA etc.). The data being pushed to the client devices not only contains lots of graphical data but also information which user is less interested. As a result, bandwidth of wireless communication is wasted, and the conventional information service systems are bulky and less efficient.

Although conventional push-pull technologies have been widely applied to internet browsers, however, since internet connection such as ADSL usually has a broad bandwidth, very few efforts have been devoted to improve the efficiency of usage of the internet bandwidth. For example, in the conventional push-pull technologies used in the internet browsers, most of the data analyses are performed by the server side, and vast amount of data (for example, graphic data such like analysis diagrams of stocks) are pushed or pulled via the internet, no matter if the client side needs them or not. In addition, whenever the client side makes a pull request, all data corresponding to that request will all be pulled from the server side back to the client side, no matter if there is already some data pre-stored in the memory of the client side or not. Moreover, the server side of prior art tends to keep pushing data to the client side even after the user has stopped browsing the screen (for example, the user has switched the screen to show another function). Because the function of the browser of the client side is merely to “browse” the information provided by the server side, very few calculating features are employed in the client side. Which means, most calculations must be performed by the server side, not only the loading of server side is heavy, but the waste of bandwidth in transmitting unnecessary data is severe. It is obvious that the conventional push-pull technologies used in the internet browsers are not suitable to be applied in the field of wireless communication that the bandwidth is a significant concern.

### SUMMARY OF INVENTION

The first objective of the present invention is to provide a distributed push-pull information service system, which can provide information service in a more efficient and less bandwidth consumption manner.

The second objective of the present invention is to provide a distributed push-pull information service system, which distributes the loads of calculations to both server side and client side, so as to provide a balanced loading to the sever and the client.

The third objective of the present invention is to provide a distributed push-pull information service system, which includes an information service server that can broadcast realtime information to a plurality of client devices in a pushing basis, and can provide demanded information to a specific client device based on a pulling request made by that client device. The information provided by the information service server is compressed and encrypted raw data, while the client device is furnished with a graphic user interface module for transforming at least some of the raw data into graphics to be displayed by the client device. Because information transmitted between the server and the client device contains no graphical data, therefore the bandwidth consumption is lower.

The fourth objective of the present invention is to provide a distributed push-pull information service system, which includes a client device capable of sending a pulling request to an external information service server for acquiring user-demanded information. The pulling request includes a search request which contains at least a first keyword and a second keyword. The first keyword refers to a specific term to be searched; and the second keyword refers a specific time period to be searched. Any information stored in the server meets that specific term during that specific period of time will be transmitted back to the client device as a result of the search. Because the time period can be used as a keyword for performing a search, only information that the user is interested most will be transmitted to the client device.

The fifth objective of the present invention is to provide a distributed push-pull information service system. The information service system includes a client device which is furnished with a graphic user interface module that is capable of displaying at least a first frame containing a first graphic and a second frame containing a text information. Wherein, the first and second frames are independently functioning and are operative in the same time. As a result, users are able to access data and operate the client device in a more efficient way.

To achieve aforesaid objectives, the distributed push-pull information service system of the present invention generally comprises an information service server and at least one client device. The information service server is capable of providing at least a first kind and a second kind of information. The first kind of information is provided in a pushing basis by means of broadcasting, while the second kind of information is provided in a pulled basis by means of user demand. The client device is remote from the server and is capable of receiving the broadcasted first kind of information and sending a pulling request to the server for acquiring the second kind of information. The first and second kinds of information are transmitted by means of compressed and encrypted raw data. The client device further comprises a graphic user interface module for transforming at least part of the transmitted raw data into a graphic which is then displayed on the client device. The pulling request includes a search request which contains at least a first keyword and a second keyword. The first keyword refers to a specific term to be searched, and the second keyword refers a specific time period to be searched. Any information stored in the server meets that specific term during that specific period of time will be transmitted back to the client device as a result of the search.

In one preferred embodiment of the present invention, the client device further comprises:

a display module for displaying at least a text and a graphic;

a connecting module for communicating with an external information service server by using a protocol supported by that server;

a user interface for accepting commands from a user and for displaying texts and graphics on the display according to the commands, said user interface further comprising a graphic user interface module for transforming raw data into graphics; and

a core engine for interacting with the user interface and the server, and for handling data coming from the connector module, and for processing commands input from the user interface;

a data module coupling to the core engine for further processing data received from the core engine according to a type of the data and then storing the processed data to a memory;

wherein, upon communication with the server, said core engine sends an authentication to the server, and is capable of receiving at least a first kind and a second kind of information from the server when said authentication is checked to be valid by the server;

wherein, the first and second kinds of information are transmitted by means of compressed and encrypted raw data; at least some of the raw data can be transformed into at least one graphic to be displayed on the display module by means of the graphic user interface module.

In one preferred embodiment of the present invention, the information service server further comprises:

means for accessing information from at least one information provider, the information accessed from the information provider including at least a first kind and a second kind of information;

a data compression module for compressing the accessed information;

a data integration module for integrating various information of the same kind;

a realtime data broadcast module for broadcasting the first kind of information to a plurality of client devices remote from the server;

an interactive data query module for accepting a pulling request from a remote client device and sending the second kind of information to that client device according to the pulling request;

an authentication billing module for checking validity of an authentication of the client device before allowing that client device to either receive broadcasted information or send pulling requests;

at least one intelligent transfer module for controlling a data flow rate between the client devices and the server, and for transmitting pulling requests and different kinds of information between said modules;

a communication module for recognizing protocols supported by the client devices and for communicating with client devices by using the same protocols; and

a load balance firewall module coupled between the communication module and the intelligent transfer module, the load balance firewall module being able to encrypt/decrypt data to be transmitted, and to prevent data overload and hacking from the client devices.

In one embodiment of the present invention, the protocols supported by the server can be GSM, GPRS, CDMA, DAB, WLAN, ADSL or Cable.

In one embodiment of the present invention, the client device can be one of the following: Pocket PC, PDA, palm, smart phone, cellular phone, notebook, and digital TV.

In one embodiment of the present invention, the client device is a digital TV. The graphic user interface module is capable of displaying at least a first frame containing a first graphic relating to stock information, a second frame containing a text information, and a third frame showing a TV program. The first, second and third frames are independently functioning and are operative in the same time.

### BRIEF DESCRIPTION OF THE DRAWINGS

The details of the present invention will be more readily understood from a detailed description of the preferred embodiments taken in conjunction with the following figures.

FIG. 1 is a system block diagram schematically showing a first embodiment of the distributed push-pull information service system according to the present invention.

FIG. 2 is a block diagram illustrating a first embodiment of the client device according to the present invention.

FIG. 3 is a block diagram illustrating the software modules of a first embodiment of the information service server of the present invention.

FIG. 4 is a block diagram illustrating the interconnecting relationship of the modules according to a first embodiment of the information service server of the present invention.

FIG. 5 is a schematic diagram illustrating an embodiment of data flow between the client device and the information service server according to the present invention.

FIG. 6A is a schematic diagram illustrating an embodiment of information pushing operation performed by the information service system according to the present invention.

FIG. 6B is a first schematic diagram illustrating an embodiment of information pulling operation performed by the information service system according to the present invention.

FIG. 7 is a second schematic diagram illustrating an embodiment of information pulling operation performed by the information service system according to the present invention.

FIG. 8 is a schematic diagram illustrating applications of the information service system in accordance with the present invention.

FIG. 9 is a schematic diagram illustrating an embodiment when the client device is a digital TV.

FIG. 10 is a first schematic diagram illustrating an embodiment of information pulling operation performed by the client device in accordance with the present invention.

FIG. 11 is a second schematic diagram illustrating an embodiment of information pulling operation performed by the client device in accordance with the present invention.

### DETAILED DESCRIPTION

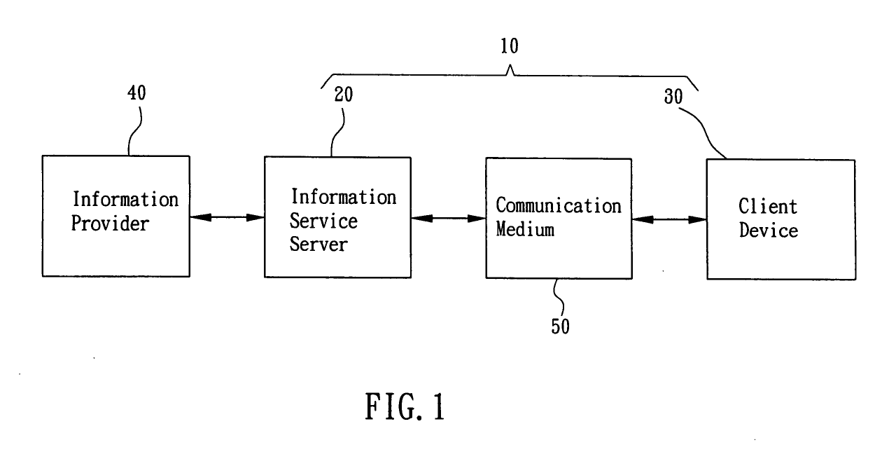

Please refer to FIG. 1, which is a system block diagram schematically showing a first embodiment of the distributed push-pull information service system according to the present invention.

The distributed push-pull information service system 10 according to the first embodiment of the present invention comprises an information service server 20 and at least one client device 30 remote from the server 20. The information service server 20 can retrieve various kinds of information from one or more information providers 40, and then reorganize these retrieved information into predetermined formats, and then compress the reorganized information to minimize its size, and then store these compressed information for later usage. Examples of the information providers 40 can be news provider such like BBC news or CNN news, stock data provider such like NYSE/NASDAQ, or even internet search engine such as Google. The client device 30 can connect to and login the server 20 via a communication medium 50 for obtaining the information stored in the server 20 by means of a pushing technique or a pulling technique. Common examples of the communication medium 50 can be GSM, GPRS, CDMA, DAB (Digital Audio Broadcasting), WLAN, ADSL or even Cable TV.

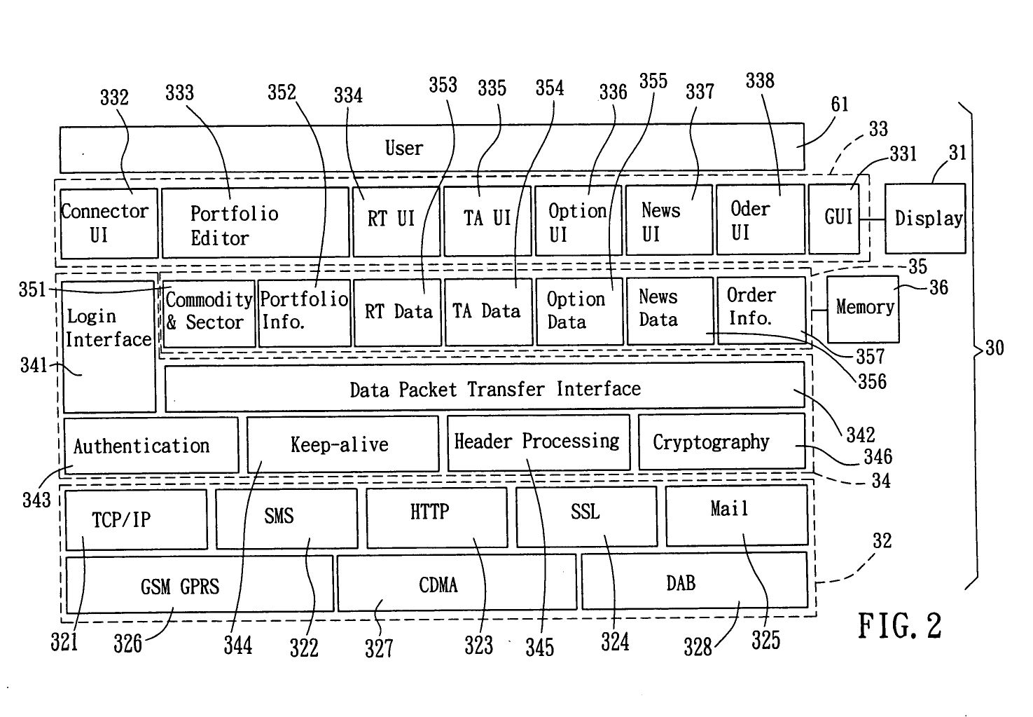

In the first embodiment of the present invention, the information provided by the information service server 20 includes at least a first kind and a second kind of information. The first kind of information will be transmitted to the client device 30 in a pushing basis, such as broadcasting. On the other hand, the second kind of information will be provided to the client device 30 in a pulled basis under user's demand. The client device 30 can send a pulling request to the server 20 for acquiring the second kind of information. Please refer to FIG. 2, which is a block diagram illustrating a first embodiment of the client device according to the present invention. The client device 30 comprises: a display module 31, a connecting module 32, a user interface 33, a core engine 34, a data module 35, and a memory 36. Upon communicating with the server 20, the core engine 34 sends an authentication to the server 20, and then the core engine 34 is capable of receiving at least the first kind and the second kind of information from the server 20 when the authentication is checked to be valid by the server 20. In this embodiment, the first and second kinds of information are transmitted by means of compressed and encrypted raw data. At least some of the raw data can be transformed into at least one graphic which is then displayed on the display module 31 of the client device 30. Because information transmitted between the server 20 and the client device 30 contains no graphical data, therefore the bandwidth consumption is lower. Therefore, the information service server 20 of the present invention is operating more efficiently and is “thinner” than the information service server of prior art.

The display module 31 can display at least a text and a graphic. Common examples of the display module 31 can be TFT LCD, STN LCD, plasma display, image projector, monitor and etc.

The connecting module 32 can communicate with the external information service server 20 by using a protocol supported by that server 20. Common examples of the protocol which can be applied in the present invention include but not limited to: GSM, GPRS, CDMA, DAB, WLAN, LAN, ADSL, Cable TV, and etc. In this preferred embodiment, the connecting module 32 of the client device 30 further comprises: a TCP/IP module 321 for communicating using WLAN/LAN protocol, an SMS module 322 for performing SMS functions, an HTTP module 323 for accessing and browsing internet via ADSL, an SSL module 324 for performing secured internet trading, a Mail module 325 for receiving/sending Email via internet, a GSM/GPRS module 326 for communicating using GSM/GPRS protocol, a CDMA module 327 for communicating using CDMA protocol, and a DAB module 328 for communicating using DAB protocol.

The user interface 33 can accept commands from a user 61 and display texts and graphics on the display module 31 according to the commands. The user interface 33 further comprises: a graphic user interface module 331, a connector UI module 332, a portfolio editor UI module 333, a RT UI module 334, a TA UI module 335, an option UI module 336, a news UI module 337, and an order UI module 338. The graphic user interface module 331 is able to transform raw data into graphics, and to transform locations of the graphic into raw data such like time periods. The connector UI (User Interface) module 332 can present a login screen on the display module 31 and allow the user 61 to perform login operation. The portfolio editor UI module 333 allows the user 61 to select stocks, news, or other information (such like leisure information, entertainment information, weather information, traffic information, banking information, sports information, gaming information, gambling information, commerce information etc.) according to the commodity & sector module 351, and to edit user-defined stock data according to the portfolio information module 352. The RT (Real Time) UI module 334 allows the user 61 to access data processed by the RT Data Storage-Parsing-Interpretation Engine 353. The TA (Technical Analysis) UI module 335 not only allows the user 61 to access historical data, but also the data processed by the TA data module 354 and to generate corresponding technical diagrams or graphics that can be displayed on the display module 31. The option UI module 336 allows the user 61 to access data processed by the option data module 355. The news UI module 337 allows the user 61 to browse news records of the new data module 356. The order UI module 338 allows the user 61 to make orders to buy or sell stock or option or future commodities via the order information module 357.

The core engine 34 is able to interact with the user interface 33 and the server 20, and to handle data coming from the connector module 32, and to process commands input from the user interface 33. In the first preferred embodiment, the core engine 34 further comprises: a login interface module 341, a data packet transfer interface module 342, an authentication module 343, a keep-alive module 344, a header processing module 345, and a cryptography module 346. The login interface module 341 can establish communication between the client device 30 and the server 20, and can establish intercommunication between other modules of the client device 30. The data packet transfer interface module 342 can provide a unified format of data packages for data module 34, even when the data packages are from different connecting module 32, using different protocols, or containing different types of information. The authentication module 343 can generate and send the authentication to the server 20 when the user 61 tries to login the server 20 by operating the connector interface 33. The keep-alive module 344 can maintain connection between the client device 30 and the server 20, even when the user 61 does not operate the client device 30 for a period of time or when there is a transmission interruption due to the nature of mobile environment. The header processing module 345 is to process headers of data packages. The cryptography module 346 is to encrypt and decrypt data.

The data module 35 is coupled to the core engine 34 for further processing data received from the core engine 34 according to the type of data and then storing the processed data to a memory 36. In the first preferred embodiment, the data module 35 further comprises: a commodity & sector module 351, a portfolio information module 352, a RT Data Storage-Parsing-Interpretation Engine 353, a TA data module 354, an option data module 355, a news data module 356, and an order information module 357. The commodity & sector module 351 is for processing data in the type of name and classification of stock data. The portfolio information module 352 is for processing data in the type of user-defined stock data. The RT Data Storage-Parsing-Interpretation Engine 353 is for processing, calculating and analysing data in the type of realtime stock data. The TA data module 354 is for processing data in the type of historical stock data and company profile and financial statements etc. The option data module 355 is for processing data in the type of option market data. The news data module 356 is for processing data in the type of news. The order information module 357 is for processing data in the type of user's order data.

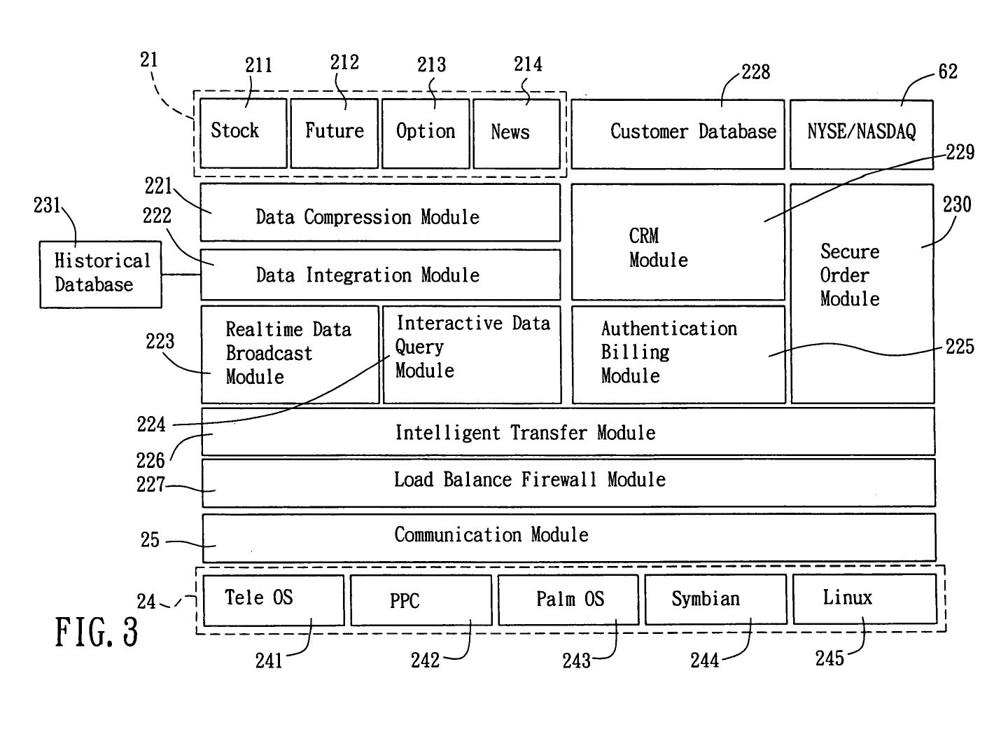

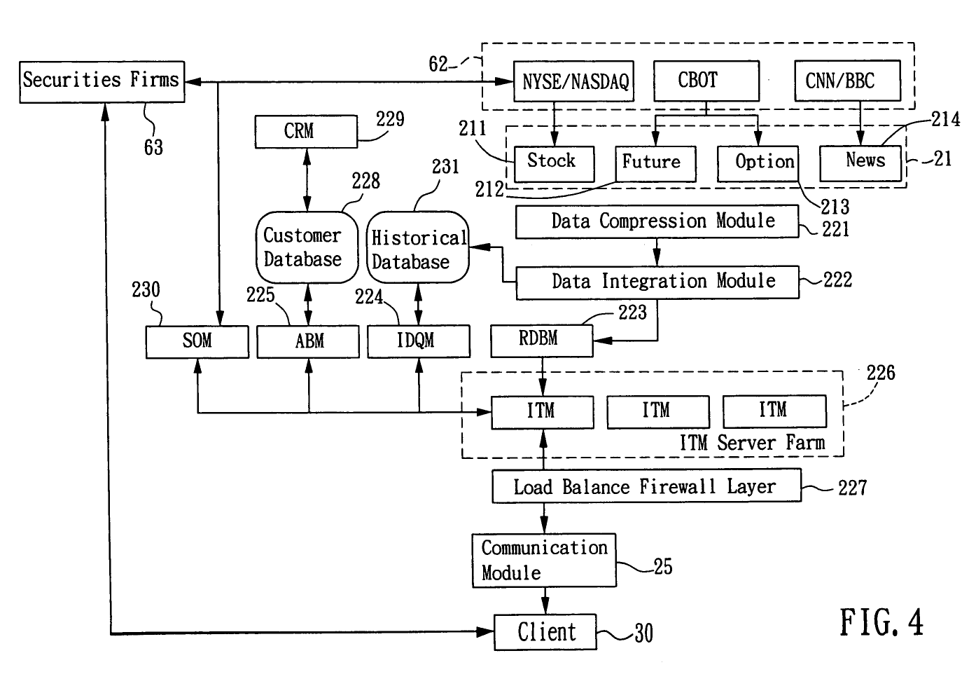

Please refer to FIG. 3 and FIG. 4, which respectively are block diagrams illustrating the software modules and interconnecting relationship of these modules according to a first embodiment of the information service server of the present invention. The information service server 20 comprises: means for accessing information 21, a data compression module 221, a data integration module 222, a realtime data broadcast module 223, an interactive data query module 224, an authentication billing module 225, at least one intelligent transfer module 226, a load balance firewall module 227, a customer database 228, a CRM module 229, a secure order module 230, a historical database 231, a communication module 25, and a client's operating system module 24. The means for accessing information 21 can access information from at least one information provider 40 (shown in FIG. 1), such as stock data provider, future commodities data provider, option data provider and news provider. The information accessed from the information providers 40 includes at least a first kind and a second kind of information. The data compression module 221 is able to compress the accessed information to minimize the size. The data integration module 222 is to integrate various information of the same kind into a predefined format of data so as to decrease the frequency for connecting the information providers 40. Different kinds of information, for example realtime stock data and historical stock data, can be further integrated in different formats for facilitating efficiency. The realtime data broadcast module 223 can broadcast the first kind of information to a plurality of client devices 30 remote from the server 20. In the preferred embodiment, the first kind of information can be a realtime information relative to one of the following: stock market, future trade market, option market, news, or other information which could include leisure information, entertainment information, weather information, traffic information, banking information, sports information, gaming information, gambling information, commerce information etc. The interactive data query module 224 can accept a pulling request from the remote client device 30 and then send the second kind of information to that client device 30 according to the pulling request. Examples of the second kind of information can be but not limited to a historical information relative to one of the following: stock market, future trade market, option market, and news.

The authentication billing module 225 checks the validity of an authentication of the client device 30 before allowing that client device 30 to either receive broadcasted information or send pulling requests. The intelligent transfer module 226 controls a data flow rate between the client devices 30 and the server 20, and transmits pulling requests and different kinds of information between these modules. When the amount of client devices 30 (ie. users) increases, the server 20 only needs to increase the number of the intelligent transfer module 226 for expanding its capacity. The communication module 25 is for recognizing protocols supported by the client devices 30 and for communicating with client devices 30 by using the same protocols. Examples of the above mentioned communication protocols can be but not limited to: TCP/IP, SMS, HTITP, SSL, GSM/GPRS, CDMA or DAB. The client's operating system module 24 presents examples of the operating systems of client devices 30, which could be supported by the server 20. In this embodiment, the client's operating system module 24 can further comprises a A8 Tele OS module 241 which supports a protocol specially designed by the designer of the system, a PPC module 242, a Palm module 243, a Symbian module 244 and a Linux module 245. Typical examples of communication protocols which might be used by the operating systems of client devices 30 and yet be supported by the server 20 of the present invention can be but not limited to: GSM, GPRS, CDMA, DAB, WLAN, ADSL and Cable TV. The load balance firewall module 227 is coupled between the communication module 25 and the intelligent transfer module 226. The load balance firewall module 227 is able to encrypt/decrypt data to be transmitted, and to prevent data overload and hacking from the client devices 30. The customer database 228 stores customer data of client devices 30. The customer data includes at least the validity of authentication of the client device 30. The CRM module 229 is connected with the customer database 228 for allowing users of the client devices 30 to make payments for obtaining valid authentications, or to perform on-line purchasing of stocks, options or future commodities. The secure order module 230 is connected between the intelligent transfer module 226 and an external trading organization 62 such as NYSE, NASDAQ through security firms 63 such as Fidelity or AmeriTrade. The secure order module 230 provides a secure mechanism for users of the client devices 30 to make trading orders to that trading organization 62 through said server 20 in condition that the authentication of that client device 30 is valid. The historical database 231 is connected to the data integration module 222. Information obtained (including historical information) from the information providers 40 is first compressed by the data compression module 221 and then integrated by the data integration module 222 and then stored in the historical database 231 for later usage.

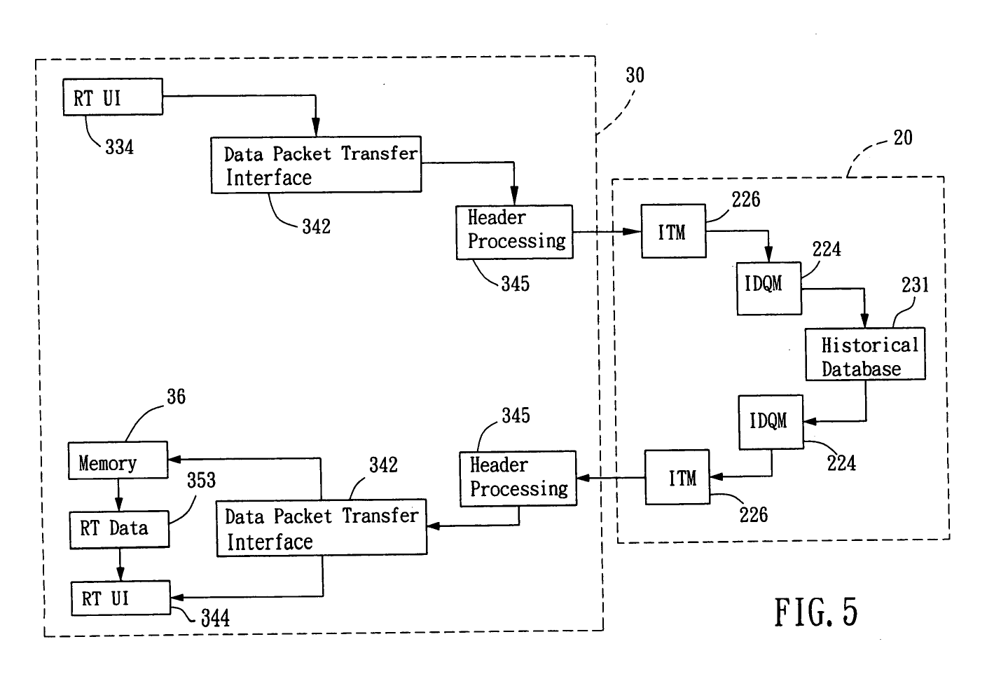

Please refer to FIG. 5, which is a schematic diagram illustrating an embodiment of data flow between the client device 30; and the information ser-vice server 20 according to the present invention. In this embodiment, the data flows between the client device 30 and the server 20 can generally be divided into four kinds: authentication, push, pull, and keep-alive.

(A) Authentication Flow:

A client user 61 operates the client device 30 by using the user interface 33 to send his/her account, password, and IMEI (or other unique number, i.e. UID) to the authentication billing module 225 through intelligent transfer module 226 of the server 20. The authentication billing module 225 verifies these information and sends back the server's 20 IP and port with client's access right to the client device 30 through the intelligent transfer module 226. The client device 30 then ends this authentication process after receiving the information.

An example of detailed operation of the authentication process is illustrated as following:

1. The user 61 operates the client device 30 and switches it into the screen of “connector UI 332”, then input his/her account number and password, and then click “login” or “transmit”.

2. The connector UI 332 transmits the information of account number and password to the login interface 341 to add the information of IMEI (or UID) of that client device 30. Then the combined information is encrypted by the authentication module 343 and is added with a header for distinguishing the type of the data (such as Authentication), and then is transmitted to the intelligent transfer module 226 of the server 20.

3. When the intelligent transfer module 226 receives the authentication data, it will transmit this authentication data to the authentication billing module 225 for checking its validity.

4. When the authentication billing module confirms that the account number, password and deadline for using the service are still valid, a confirmation signal (i.e. the result of authentication) will be sent back to the authentication module 343 of client device 30 via the intelligent transfer module 226 of server 20.

5. The authentication module 343 of client device 30 transmits such result of authentication to the connector UI 332 through the login interface 341.

6. The connector UI 332 displays the result of authentication on the display module 31. If the result of authentication is “valid”, then the server's 20 IP and port information will be stored in the memory 36 of client device 30 for later push/pull operations.

(B) Push Flow:

After a client user is verified through the authentication flow, the client device 30 can start the push flow as described below. First, the client device 30 sends its portfolio and access right to the intelligent transfer module 226 of server 20. Then, when the intelligent transfer module receives these portfolio information and client's access right, it begins filtering the data from realtime data broadcast module 223 according to its portfolio and access right, and then pushes the data to the client device 30. The push flow ends when the client device 30 closes the connection.

The distributed information service system of the present invention also discloses the concept of “Intelligent Push”, that is, only the information which is currently requested by the user 61 will be pushed to the client device 30 instantly. Unlike the historical information such as news or technical analyses which are not time critical, such information to be transmitted by “Intelligent Push” is usually time critical and is meaningful only at that time when the user 61 is making the request. Once the user 61 stops watching the screen, such as switching the screen into other functions or system switch to screen saving mode, then it will be meaningless for the server 20 to keep pushing such information to the client device 30. Therefore, such “Intelligent Push” will be started for sending realtime data at the time when the user 61 makes the request, and will be stopped anytime when the user 61 leaves the current screen. As a result, only most interested information or data will be pushed at most desired time, and thus the usage of bandwidth is highly efficient.

An example of detailed operation of the “Intelligent Push” process is illustrated as following:

1. The user 61 operates the client device 30 and switches it into the screen of “top five bid-ask records” of RT UI module 334.

2. The RT UI module 334 transmits the code of stock currently shown on the display module 31 to the data packet transfer interface 342.

3. The information of the code of stock is then added with a header (or command) for distinguishing the type of the data (such as “top five bid-ask records”), and then transmitted to the intelligent transfer module 226 of the server 20.

4. Upon receiving this header (command), the intelligent transfer module 226 will instantly add the information of “top five bid-ask records” of this stock at that time into the push flow, and then push this information to the client device 30.

5. The data packet transfer interface 342 of client user 30 receives this pushed information, stores it into the memory 36, and then allows the RT UI module 334 to read and update this “top five bid-ask records” information from the R data module 353 so as to shown them onto the display module 31.

6. When the user 61 leaves the screen of “top five bid-ask records”, the RT UI module 334 sends a signal to the data packet transfer interface 342 of client device 30 to inform the finished usage of the “top five bid-ask records” function.

7. The data packet transfer interface 342 then adds a header (or command) for distinguishing the type of the data (such as “leaving top five bid-ask records”), and then transmits this command to the intelligent transfer module 226 of server 20.

8. The intelligent transfer module 226 stops adding the information of “top five bid-ask records” into the push flow after receiving this command.

(C) Keep-Alive Flow:

Once the authentication is successfully verified, the keep-alive flow starts. First, the intelligent transfer module 226 of server 20 initiates this keep-alive flow by sending keep-alive messages with queue size, current time, and other information at specified interval. Then, the keep alive module 344 of client device 30 echoes these keep-alive messages back to the intelligent transfer module 226. As the keep alive module 344 keeps responding to the keep-alive messages, the connection between the server 20 and the client device 30 continues. The keep-alive flow will be ended when the user 61 closes the connection. When the client didn't receive the keep alive message in a time period, the client assumes the connection between it and server is dead then client re-link the connection from authentication flow.

(D) Pull Flow:

During the connection is alive, a client device 30 can send the pull command to retrieve historical information from server's 20 database 231 or other information like “user defined stock data”. For example, the client device 30 sends the command to the intelligent transfer module 226 of server 20, wherein the command can include: code of stock, type of data, period of time, or other reference, etc. When the intelligent transfer module 226 receives such pull command, it sends a control signal (command) to the interactive data query module 224 so as to acquire corresponding data from the database 231. This corresponding data is then pulled back to the client device 20. Finally, the client device 20 ends this “Pull Flow” service by closing the connection.

The distributed information service system of the present invention also discloses the concept of “Intelligent Pull”, that is, when the user 61 makes a pull request, only the information which is absent in the memory 36 of client device 30 will be pulled. Unlike the conventional pulling technology which always pull all information corresponding to the user's pull request, the “Intelligent Pull” technology of the present invention will firstly check the content of the memory 36 to find out the latest data relevant to the request, and then only the missing data will be pulled from the server 20, and thus the usage of bandwidth is highly efficient.

An example of detailed operation of the “Intelligent Pull” process is illustrated as following:

Please refer to FIG. 5, and take the function of “realtime chart of stock” as an example for illustration.

1. The user 61 operates the RT UI module 334 and switches the screen to show “realtime chart of stock”.

2. The RT UI module 334 checks the content of the memory 36, and find out that the latest data stored in the memory 36 relevant to the selected stock is till AM 10:00, however, the current time is AM 11:00 now. Therefore, the RT UI module 334 sends the parameters of command including the code of stock and the time period of update (e.g., AM 10:00˜11:00) to the data packet transfer interface 342.

3. The data packet transfer interface 342 adds a header (or command) to these parameters to become a complete command for distinguishing the type of the data (such as “detail transaction records of this stock”), and then transmits it to the intelligent transfer module 226 of the server 20.

4. The intelligent transfer module 226 decrypts this command, reads the type of data, code of stock, and time period of update, and transmits these parameters to the interactive data query module 224.

5. The interactive data query module 224 then acquires corresponding data based on these parameters, and transmits those corresponding data back to the client device 30.

6. The data packet transfer interface 342 of client device 30 receives and stores those corresponding data into the memory 36, and then sends a control signal (command) to the RT UI module 334.

7. The RT UI module 334 access the complete data (including the data pre-stored in the memory and the data currently received) from the memory 36 through the RT Data Storage-Parsing-Interpretation Engine 353, and then refresh the diagram of realtime stock price shown on the screen of display module 31.

In this preferred embodiment, the distributed information service system of the present invention further discloses the concept of “Filter by User Defined Equation”, an example of detailed operation of the “Filter by User Defined Equation” process is illustrated as following:

1. The user 61 operates the user interface 33 and switches the display module 31 into the screen of “Filter by User Defined Equation”, and then input the conditions of user's choice, for example, top five of most popular stocks, top five of stocks with highest price-raise, and etc.

2. The user interface 33 sends these conditions to the data packet transfer interface 342.

3. The data packet transfer interface 342 adds a header (or command) to these conditions to become a complete command for distinguishing the type of the data (such as “Filter by User Defined Equation”), and then transmits it to the intelligent transfer module 226 of the server 20.

4. The intelligent transfer module 226 decrypts this command, reads the conditions, and then transmits these conditions to the interactive data query module 224.

5. The interactive data query module 224 then acquires corresponding data based on these conditions, and transmits those corresponding data through the intelligent transfer module 226 back to the client device 30.

6. The data packet transfer interface 342 of client device 30 receives and stores those corresponding data into the memory 36, and then refresh the screen of display module 31 to show the user defined stock data.

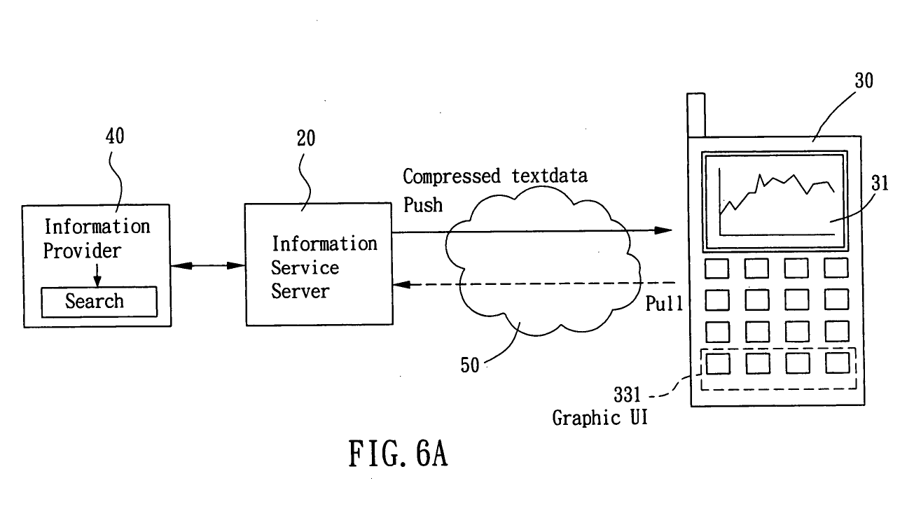

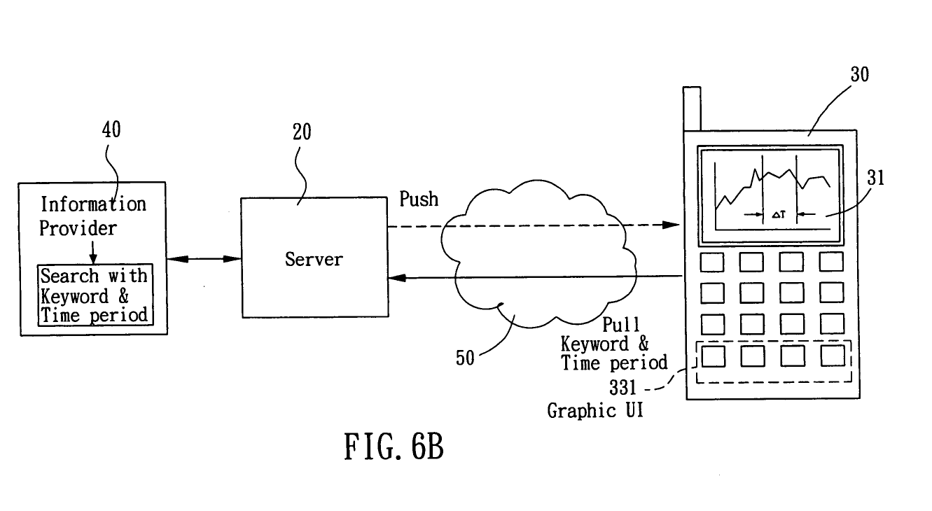

Please refer to FIG. 6A, which is a schematic diagram illustrating an embodiment of information pushing operation performed by the information service system according to the present invention. The information service server 20 acquires raw data from the information provider 40, and then compresses, integrates and encrypts the raw data, and then transmits the compressed raw data to the client device 30 by means of broadcasting in a pushing basis. The client device 30 includes a graphic UI module 331 which can transform at least part of the raw data into at least one graphic which can be displayed on the display module 31 of the client device 30.

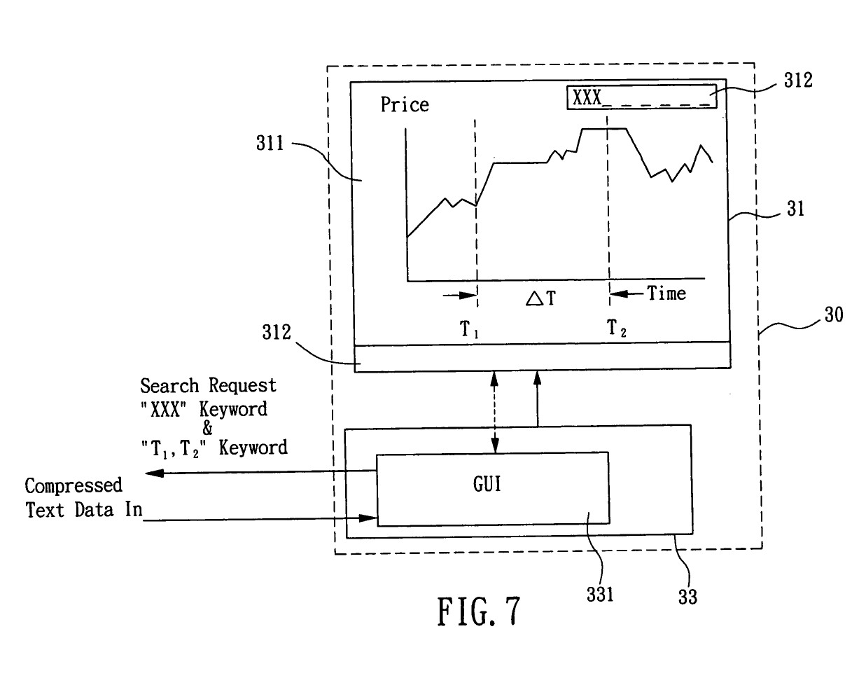

Please refer to FIG. 6B and FIG. 7, which are schematic diagrams illustrating an embodiment of information pulling operation performed by the information service system according to the present invention. The client device 30 is able to send a pulling request to the server 20. The server 20 then acquires data based on the request from either its own database or the information provider 40 and then compresses, integrates, encrypts and sends the data to the client device 30. In this embodiment, the pulling request is a search request which contains at least a first keyword and a second keyword.

The first keyword refers to a specific term to be searched; and the second keyword refers a specific time period to be searched. Any information stored in the server 20 meets that specific term during that specific period of time will be transmitted to the client device 30 as a result of the search. Moreover, the time period can be selected by choosing two different locations of a graphic shown on the display module 31 by using the graphic user interface module 331. Locations of the graphic will then be transformed to corresponding raw data of time periods so as to act as keywords “T1” and “T2”. Typically, the unit of time period “T1” and “T2” can be as short as seconds, or as long as months, depending on the type of information. For example, for time sensitive information such as future/option/best-five records, the time period can be as short as seconds. However, for some information such like news/reports/historical-data, the time period can be as long as months or even years. Because the time period can be used as a keyword for performing a search, only information that the user is interested most will be transmitted to the client device 30. Moreover, the graphic user interface module 331 is capable of displaying on the display module at least a first frame 311 containing a first graphic and a second frame 312 containing text information; wherein the first and second frames 311, 312 are independently functioning and are operative in the same time. As a result, users are able to access data and operate the client device 30 in a more efficient way.

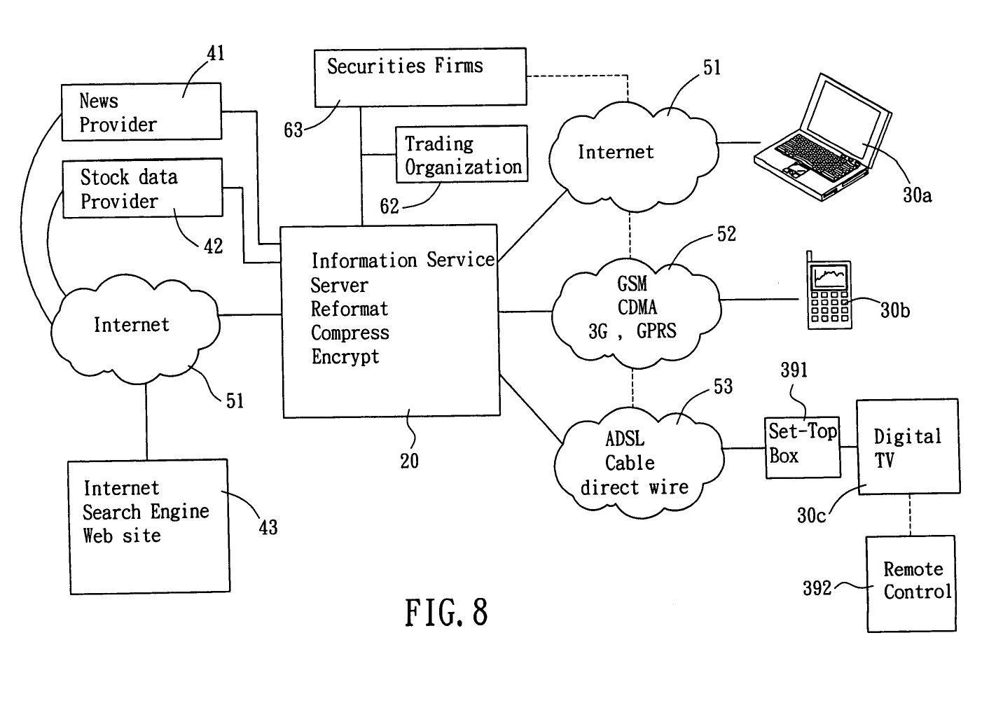

Please refer to FIG. 8, which is a schematic diagram illustrating applications of the information service system in accordance with the present invention. The information service server 20 can connect to the news provider 41 and stock data provider 42 by using Internet 51 or direct wiring connections, and also can connect to the Internet search engine 43 via Internet 51. Information acquired from the news provider 41 and stock data provider 42 is compressed, integrated (reformatted) and then stored in the database of the server 20. Client devices 30 such like notebook 30a, PDA 30b (or Pocket PC, palm, smart phone, cellular phone) and digital TV 30c can connect to the server 20 via either Internet 51, GSM/CDMA/3G/GPRS 52, or ADSL/Cable/Direct-Wire 53 through a set-top box 391 which is further controllable by a remote control 392. Client devices 30a, 30b and 30c can perform trading of stock or option or future commodities with trading organization 62 through the server 20 of the present invention.

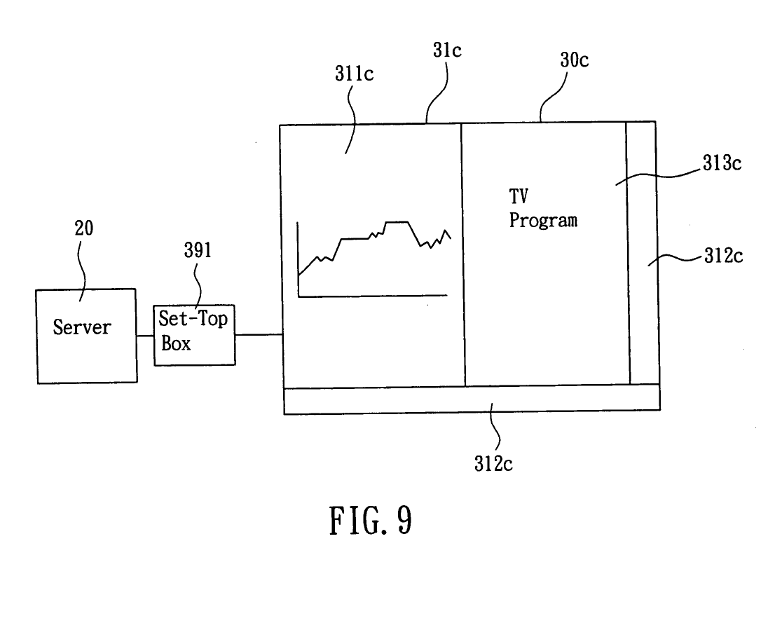

Please refer to FIG. 9, which is a schematic diagram illustrating an embodiment when the client device is a digital TV 30c. When the client device is a digital TV 30c, then the graphic user interface module of the present invention will be capable of displaying on the display module 31c at least a first frame 311c containing a first graphic relating to stock information, two second frames 312c containing text information, and a third frame 313c showing a TV program; wherein said first, second and third frames 311c, 312c and 313c are independently functioning and are operative in the same time. Such that user will be able to watch television while browsing stock information and receive pushed information.

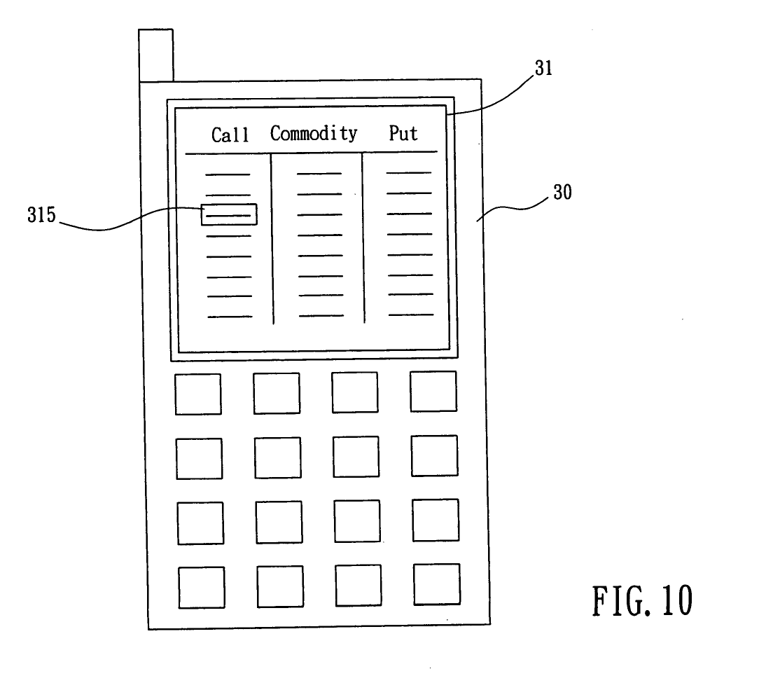

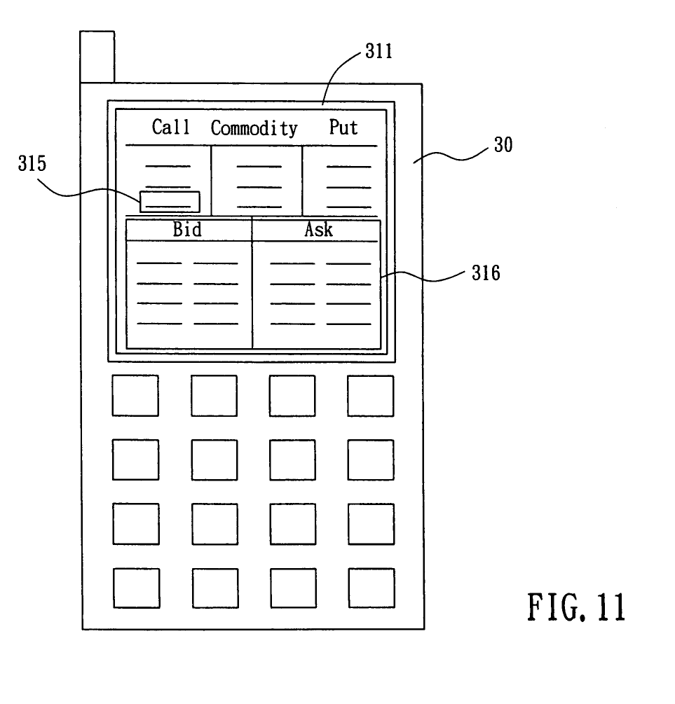

Please refer to FIG. 10 and FIG. 11, which are schematic diagrams illustrating an embodiment of information pulling operation performed by the client device in accordance with the present invention. When the data displayed on the display module of the client device 30 contains a list of realtime trading data such like stock data, option data or future commodity data, the user will be able to select and click any item 315 shown on the display module 31 for actuating an information pulling procedure, as shown in FIG. 10. The client device 30 will then send a pulling request to the information service server, and then acquire compressed and yet encrypted raw data of the top five Bid-Ask prices and their volume according to that selected item 315, and then present these top five Bid-Ask prices and their volume on the display module 31 in the form of a POP-UP screen 316. Moreover, the client device 30 of the present invention can also provide the function that allows the user to define alert conditions in advance, for example, time to alert, profit ratio alert, damage-stopping alert, abnormal alert, and etc. When any one of the predefined alert conditions is fulfilled, for example, the time is now AM 12:30, the profit made has achieved 150%, the price of stock is lower than US$ 5, or the transaction of a stock is higher than an abnormally value, then the client device 30 will send out an alert signal to remind the user to buy or sell the stock. Moreover, by using the RT Data Storage-Parsing-Interpretation Engine 353, the user can also define his/her own equation as the condition of alert. For example, the user can set the alert to inform the user to see the best five hits of stocks which are worth to buy or sell after sixty minutes later. The RT Data Storage-Parsing-Interpretation Engine 353 will then analyse the stock data and to predict which stock is most likely to raise or drop its price. That means, the RT Data Storage-Parsing-Interpretation Engine 353 of the present invention not only can receive, store and present the realtime information, but also can perform calculation and analysis to the information before presenting the result to the user.

While the invention has been described by way of examples and in terms of the preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures. Accordingly, that above disclosure should be construed as limited only by the metes and bounds of the appended claims.

What is claimed is:

1. A distributed push-pull information service system, comprising a server for providing information service, said server further comprising:
means for accessing information from at least one information provider, the information accessed from the information provider including at least a first kind and a second kind of information;
a data compression module for compressing the accessed information;
a data integration module for integrating various information of the same kind;
a realtime data broadcast module for broadcasting the first kind of information to a plurality of client devices remote from the server;
an interactive data query module for accepting a pulling request from a remote client device and sending the second kind of information to that client device according to the pulling request;
an authentication billing module for checking validity of an authentication of the client device before allowing that client device to either receive broadcasted information or send pulling requests; and
at least one intelligent transfer module for controlling a data flow rate between the client devices and the server, and for transmitting pulling requests and different kinds of information between said modules.

2. The distributed push-pull information service system according to claim 1, wherein the server further comprises:
a communication module for recognizing protocols supported by the client devices and for communicating with client devices by using the same protocols; and a load balance firewall module coupled between the communication module and the intelligent transfer module, the load balance firewall module being able to encrypt/decrypt data to be transmitted, and to prevent data overload and hacking from the client devices.

3. The distributed push-pull information service system according to claim 1, wherein said protocols comprises at least one of the following: GSM, GPRS, CDMA, DAB, WLAN, ADSL and Cable.

4. The distributed push-pull information service system according to claim 1, wherein the client device is chosen from one of the following: Pocket PC, PDA, palm, smart phone, cellular phone, notebook, and digital TV.

5. The distributed push-pull information service system according to claim 1, wherein the server further comprises:
a customer database for storing customer data of client devices, said customer data including at least the validity of authentication of the client device; and
a CRM module connected with the customer database for allowing users of the client devices to make payments for obtaining valid authentications.

6. The distributed push-pull information service system according to claim 1, wherein the server further comprises:
a secure order module connected between the intelligent transfer module and an external trading organization, said secure order module providing a secure mechanism for users of the client device to make trading orders to that trading organization through said server in condition that the authentication of that client device is valid.

7. The distributed push-pull information service system according to claim 1, wherein the first kind of information comprises a realtime information relative to one of the following: stock market, future trade market, option market, news, leisure information, entertainment information, weather information, traffic information, banking information, sports information, gaming information, gambling information, and commerce information.

8. The distributed push-pull information service system according to claim 1, wherein the second kind of information comprises a historical information relative to one of the following: stock market, future trade market, option market, news, leisure information, entertainment information, weather information, traffic information, banking information, sports information, gaming information, gambling information, and commerce information.

9. The distributed push-pull information service system according to claim 8, wherein the server further comprises:
a historical database connected to the data integration module, information obtained from the information providers is first compressed by the data compression module and then integrated by the data integration module and then stored in the historical database;
wherein, the historical information is stored in the historical database.

10. The distributed push-pull information service system according to claim 9, wherein the pulling request made by the client device is a search request and contains at least a first keyword and a second keyword; the first keyword refers to a specific term to be searched; and the second keyword refers a specific time period to be searched; any information stored in the historical database meets that specific term during that specific period of time will be transmitted to the client device as a result of the search.

11. A distributed push-pull information service system, comprising a client device, said client device further comprising:
a display module for displaying at least a text and a graphic;
a connecting module for communicating with an external information service server by using a protocol supported by that server;
a user interface for accepting commands from a user and for displaying texts and graphics on the display module according to the commands, said user interface further comprising a graphic user interface module for transforming raw data into graphics; and
a core engine for interacting with the user interface and the server, and for handling data coming from the connector module, and for processing commands input from the user interface; and
a data module coupling to the core engine for further processing data received from the core engine according to a type of the data and then storing the processed data to a memory;
wherein, upon communicating with the server, said core engine sends an authentication to the server, and is capable of receiving at least a first kind and a second kind of information from the server when said authentication is checked to be valid by the server;
wherein, the first and second kinds of information are transmitted by means of compressed and encrypted raw data; at least some of the raw data can be transformed into at least one graphic to be displayed on the display module by means of the graphic user interface module.

12. The distributed push-pull information service system according to claim 11, wherein the connecting module of the client device is capable of communication by using a protocol chosen from the following: GSM, GPRS, CDMA, DAB, WLAN, ADSL and Cable.

13. The distributed push-pull information service system according to claim 11, wherein the connecting module of the client device further comprises: a TCP/IP module, an SMS module, an HTTP module, an SSL module, a Mail module, a GSM/GPRS module, a CDMA module and a DAB module.

14. The distributed push-pull information service system according to claim 11, wherein the client device is chosen from one of the following: Pocket PC, PDA, palm, smart phone, cellular phone, notebook, and digital TV.

15. The distributed push-pull information service system according to claim 11, wherein the core engine of the client device further comprises: a login interface module for establishing communication between the client device and the server, and for establishing intercommunication between other modules of the client device;
a data packet transfer interface module for providing a unified format of data packages for data module;
an authentication module for generating and sending the authentication to the server;
a keep-alive module for maintaining connection between the client device and the server;
a header processing module for processing headers of data packages; and
a cryptography module for encrypt and decrypt data.

16. The distributed push-pull information service system according to claim 11, wherein the data module of the client device further comprises:
a commodity & sector module for processing data in the type of name and classification of data;
a portfolio information module for processing data in the type of user-defined data;
a RT Data Storage-Parsing-Interpretation Engine for processing, calculating and analysing data in the type of realtime data;
a TA data module for processing data in the type of historical data and company profile and financial reports;
an option data module for processing data in the type of option market data; and an order information module for processing data in the type of user's order data.

17. The distributed push-pull information service system according to claim 16, wherein the user interface of the client device further comprises: a connector UI module for presenting a login screen on the display module and allowing the user to perform login operation; a portfolio editor UI module for allowing the user to select data according to the commodity & sector module, and to edit user-defined data according to the portfolio information module;
a RT UI module for allowing the user to access data processed by the RT Data Storage-Parsing-Interpretation Engine
a TA UI module for allowing the user to access historical data processed by the TA data module;
an option UI module for allowing the user to access data processed by the option data module; and
an order UI module for allowing the user to make orders.

18. The distributed push-pull information service system according to claim 11, wherein the commands accepted from the user interface include a search request to be sent to the server; the search request contains at least a first keyword and a second keyword; the first keyword refers to a specific term to be searched; and the second keyword refers a specific time period to be searched; any information stored in the server meets that specific term during that specific period of time will be transmitted back to the client device as a result of the search.

19. The distributed push-pull information service system according to claim 18, wherein the time period is selected by choosing two different locations of a graphic shown on the display module by using the graphic user interface module.

20. The distributed push-pull information service system according to claim 11, wherein the graphic user interface module is capable of displaying on the display module at least a first frame containing a first graphic and a second frame containing a text information; wherein said first and second frames are independently functioning and are operative in the same time.

21. The distributed push-pull information service system according to claim 11, wherein the client device is a digital TV; the graphic user interface module is capable of displaying on the display module at least a first frame containing a first graphic relating to stock information, a second frame containing a text information, and a third frame showing a TV program; wherein said first, second and third frames are independently functioning and are operative in the same time.

22. A distributed push-pull information service system comprising:
an information service server capable of providing at least a first kind and a second kind of information, said first kind of information being provided in a pushing basis by means of broadcasting, said second kind of information being provided in a pulled basis by means of user demand; and
at least one client device which is remote from the server, said client device being capable of receiving said broadcasted first kind of information and sending a pulling request to the server for acquiring the second kind of information;
wherein the first and second kinds of information are transmitted by means of compressed and encrypted raw data; said client device further comprises a graphic user interface module for transforming at least part of the transmitted raw data into a graphic which is displayed on the client device;
wherein the pulling request includes a search request which contains at least a first keyword and a second keyword; the first keyword refers to a specific term to be searched; and the second keyword refers a specific time period to be searched; any information stored in the server meets that specific term during that specific period of time will be transmitted back to the client device as a result of the search.

23. The distributed push-pull information service system according to claim 22, wherein the time period is selected by choosing two different locations of a graphic shown on the client device by using the graphic user interface module.

24. The distributed push-pull information service system according to claim 22, wherein the client device is chosen from one of the following: Pocket PC, PDA, palm, smart phone, cellular phone, notebook, and digital TV.

25. The distributed push-pull information service system according to claim 24, wherein the client device is a digital TV; the graphic user interface module is capable of displaying at least a first frame containing a first graphic relating to stock information, a second frame containing a text information, and a third frame showing a TV program; wherein said first, second and third frames are independently functioning and are operative in the same time.

26. The distributed push-pull information service system according to claim 22, wherein an “Intelligent Push” process is started for sending realtime data at the time when the client device starts such process, and will be stopped anytime when the client device leaves a current screen showing the realtime data; that is, only the most interested information or data will be pushed from the server to the client device at the most desired time.

27. The distributed push-pull information service system according to claim 22, wherein, when the client device makes a pulling request, the client device will firstly check the content of a memory of the client device to find out if there is pre-stored with any data relevant to the pulling request, and then only the information which is absent in the memory will be pulled from the server.

28. The distributed push-pull information service system according to claim 22, wherein, the client device is capable of:
receiving a plurality of realtime trading data from an information service server;
presenting a list of the realtime trading data on a display module of the client device;
selecting one of the listed realtime trading data shown on the display module;
sending a pulling request to the information service server for acquiring compressed and yet encrypted raw data of top five Bid-Ask prices according to that selection; and,
presenting the top five Bid-Ask prices on the display module of the client device in the form of a POP-UP screen.

29. The distributed push-pull information service system according to claim 22, wherein, the client device is capable of:
allowing the user to define alert conditions in advance; and,
sending out an alert signal when any one of the predefined alert conditions is fulfilled.

30. The distributed push-pull information service system according to claim 22, wherein, the client device further comprises a RT Data Storage-Parsing-Interpretation Engine that can perform calculation and analysis to the information before presenting the result of calculation and analysis on the client device.

31. A method of distributed push-pull information service, comprising:
using a client device to receive a plurality of realtime trading data from an information service server, and presenting a list of the realtime trading data on a display module of the client device;
selecting one of the listed realtime trading data shown on the display module of the client device;
sending a pulling request from the client device to the information service server, and acquiring compressed and yet encrypted raw data of top five Bid-Ask prices according to that selection; and
presenting the top five Bid-Ask prices on the display module of the client device in the form of a POP-UP screen.
